(19) United States
(12) Patent Application Publication
(10) Pub. No.: US 2021/0331488 A1
(43) Pub. Date: Oct. 28, 2021

(54) GAPS IN RESISTORS FOR THERMAL IMAGING

(71) Applicant: HEWLETT-PACKARD DEVELOPMENT COMPANY, L.P., Spring, TX (US)

(72) Inventor: Reynaldo V. Villavelez, Corvallis, OR (US)

(21) Appl. No.: 16/603,577

(22) PCT Filed: Jul. 11, 2018
(86) PCT No.: PCT/US2018/041669

§ 371 Date: Oct. 7, 2019

(51) Int. Cl. B41J 2/335; B41J 2/345

(52) U.S. Cl. CPC B41J 2/3354; B41J 2/345; B41J 2/3357

(57) ABSTRACT

In some examples, a thermal imaging head includes a resistor and conductors connected to end portions of the resistor to pass an electrical current through the resistor. The resistor includes gaps at the end portions of the resistor, each gap of the gaps reducing a cross-sectional area of a respective end portion of the end portions of the resistor relative to a cross-sectional area of a central portion of the resistor.

### BACKGROUND

A thermal printer refers to a printer that is able to print images onto a heat-sensitive print medium without dispensing printing fluids such as ink. A thermal printhead of the thermal printer generates heat that is applied onto a thermochromic print medium (hereinafter referred to as a “thermal print medium”).

### BRIEF DESCRIPTION OF THE DRAWINGS

Some implementations of the present disclosure are described with respect to the following figures.

FIG. 1 is a schematic diagram of a thermal printer, according to some examples.

FIG. 2 is a top view of a heating element that includes a resistor with thermal control gaps according to some examples.

FIGS. 3A and 3B are cross-sectional views of respective portions of the heating element of FIG. 2.

FIG. 3C illustrate thermal profiles according to some examples.

FIG. 4 is a sectional view of a portion of the heating element of FIG. 2.

FIGS. 5 and 6 are top views of heating elements according to further examples.

FIGS. 7A-7F illustrate thermal control gaps according to various examples.

FIG. 8 is a block diagram of a thermal imaging head according to some examples.

FIG. 9 is a block diagram of a thermal imaging device according to some examples.

FIG. 10 is a flow diagram of forming a thermal imaging head according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Heat produced by a thermal printhead of a thermal printer activates portions of a thermal print medium to generate a colored image on the thermal print medium. A thermal print medium can include heat-sensitive color-forming layers with dyes (of respective colors, such as yellow, magenta, and cyan, or other colors) that are initially colorless (or transparent). For example, a dye of a heat-sensitive color-forming layer can include crystals of amorphochromic dye that convert to a colored form by melting due to application of heat produced by a thermal printhead. The dye retains its color after re-solidification when heat is removed.

In other examples, instead of using multiple heat-sensitive color-forming layers, a thermal print medium can include one color-forming layer that includes dyes of different colors that can be activated by heat.

An issue that can occur with thermal printing is color crosstalk and/or whitespace caused by the presence of hotspots in a thermal printhead. The thermal printhead includes an array of heating elements, where each heating element includes a resistor. Each resistor in the array is connected between electrical conductors. Electrical current is passed through a resistor between the electrical conductors. The resistor can be divided into three portions: a first end portion connected to a first electrical conductor, a second end portion connected to a second electrical conductor, and a central portion between the first and second end portions.

A thermal profile of heat generated by the resistor can be a Gaussian profile, caused by the central portion of the resistor generating a greater amount of heat than the end portions of the resistor. Thus, the thermal profile can have a higher temperature near the center of the resistor and lower temperatures at the ends of the resistor. The higher temperature near the center corresponds to a hotspot of the resistor.

Crosstalk occurs when heat applied by a thermal printhead to activate a first heat-sensitive color-forming portion (for a first color) of a thermal print medium also inadvertently activates a second heat-sensitive color-forming portion (for a second color) of the thermal print medium. As a result, instead of activating just the first color of the thermal print medium, heat applied by the thermal printhead (and in particular heat from hotspots of the thermal printhead) can also activate the second color of the thermal print medium, which results in an image portion formed on the thermal print medium that does not have a target color (i.e., instead of the image portion having the first color, the image portion has a color based on a mixture of the first and second colors). In some cases, hotspots in the thermal printhead can activate multiple other heat-sensitive color-forming portions for respective other colors.

Whitespace occurs when insufficient heat is applied to a heat-sensitive color-forming portion of a thermal print medium. A thermal printer may compensate for the presence of hotspots in the resistors by reducing the amount of power applied to the thermal printhead. However, this may result in the end portions of each resistor not generating sufficient heat, which can lead to a heat-sensitive color-forming portion of a thermal print medium not activating and therefore not providing a target color.

In the ensuing discussion, reference is made to a thermal printer that includes a thermal printhead for forming images on thermal print media. In other examples, techniques or mechanisms according to some implementations can be applied in non-printing imaging devices that employ thermal imaging heads that include resistors for generating heat.

In accordance with some implementations of the present disclosure, a resistor of a thermal imaging head (e.g., a thermal printhead) is configured with a specified structure such the thermal profile of the resistor is flattened, as compared to the Gaussian profile of a resistor without the specified structure. In some examples, the thermal imaging head includes a resistor, conductors connected to end portions of the resistor to pass an electrical current through the resistor, where the resistor includes thermal control gaps at the end portions of the resistor, each of the thermal control gaps reducing a cross-sectional area of a respective end portion of the end portions of the resistor relative to a cross-sectional area of a central portion of the resistor.

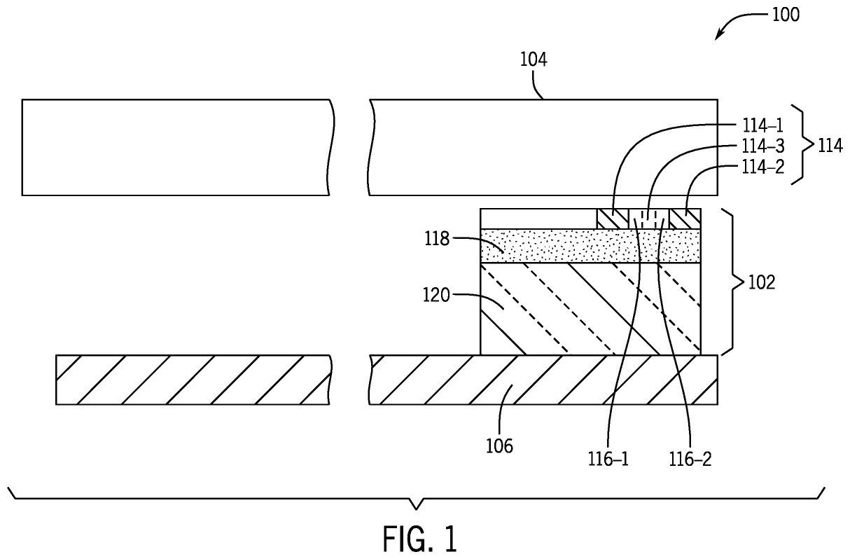

FIG. 1 is a cross-sectional view of a portion of a thermal printer 100. A thermal printer 100 includes a thermal printhead 102 that includes an array of heating elements to cause application of heat to activate heat-sensitive color-forming portions of a thermal print medium 104. The thermal printhead 102 is mounted on a backing plate 106, which forms an overall support for the printhead 102. The backing plate can be formed of a metal (e.g., aluminum or another metal), or a different material.

A circuit board (not shown) in the thermal printer 100 includes electronic components that are used to drive activation signals to the array of heating elements of the printhead 102. The circuit board can be mounted on a surface of the backing plate 106 or on the printhead 102. The circuit board can include an integrated circuit (IC) device that has driving circuitry to drive electrical current over conductors to the array of heating elements of the printhead 102.

The cross-sectional view of FIG. 1 depicts a heating element 114 (of an array of heating elements). The heating element 114 includes electrical conductors 114-1 and 114-2 and a resistor 114-3 connected between the electrical conductors 114-1 and 114-2. As further depicted in FIG. 1, the resistor 114-3 includes thermal control gaps 116-1 and 116-2 formed in the end portions of the resistor 114-3, to allow the resistor 114-3 to produce a more flattened thermal profile as compared to a Gaussian thermal profile that can be produced by traditional thermal resistors.

The array of heating elements 114 is formed on a glaze layer 118, which can include a glass material (e.g., silicon dioxide). Additionally, the glaze layer 118 is formed on a ceramic layer 120. The ceramic layer can include alumina (Al₂O), for example. In other examples, the layers 118 and 120 can be formed of other materials. For example, the layer 120 can be formed of a material including silicon or another material.

In further examples, other arrangements of a printhead 102 can be used (with some of the layers shown in FIG. 1 omitted, for example).

Although not shown, the thermal printer 100 can include a receiving slot through which the thermal print medium 104 is passed to allow a portion of the thermal print medium 104 to be brought into proximity with the array of heating elements 114. Selective activation of heating elements of the array of t heating elements 114 causes different portions of the thermal print medium 104 to be activated to produce an image containing respective colors. The thermal print medium can be moved relative to the thermal printhead 102 to cause the formation of the image on a target area of the thermal print medium 104.

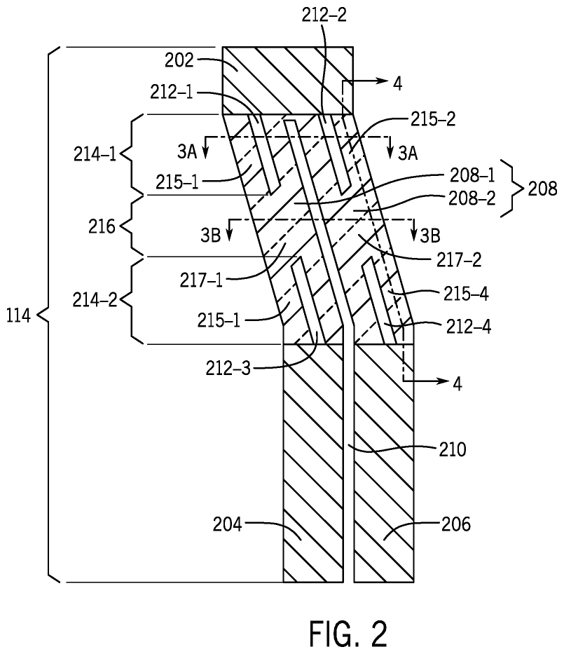

FIG. 2 is a top view of a heating element 114 according to some examples. The heating element 114 includes electrical conductors 202, 204, and 206. The heating element 114 further includes a resistor 208. In the example arrangement shown in FIG. 2, the resistor 208 is a split resistor that has a first resistor segment 208-1 and a second resistor segment 208-2 separated at least partially by a longitudinal gap 210 extending generally along the length of the resistor 208 and the conductors 204 and 206.

The longitudinal gap 210 separates the resistor segments 208-1 and 208-2, and also separates the conductors 204 and 206.

In other examples, the longitudinal gap 210 is omitted such that a split resistor design is not used. In such examples, the conductors 204 and 206 become one conductor that couples through the resistor 208 to the conductor 202.

An electrical current is passed between the electrical conductors 202 and 204 through the resistor segment 208-1, and an electrical current is passed between the conductors 202 and 206 through the resistor segment 208-2.

In accordance with some implementations of the present disclosure, thermal control gaps 212-1, 212-2, 212-3, and 212-4 are formed in the resistor 208. A thermal control gap is formed by removing the resistive material of the resistor 208, such that an opening is formed in the resistor 208. The opening can be filled with a material that is different form the resistive material of the resistor 208. For example, the thermal control gaps 212-1, 212-2, 212-3, and 212-4 can be filled with the material of an overcoat layer covering the resistor 208. An example of an overcoat material can include silicon nitride (SiN), or another dielectric (i.e., electrically insulating) material.

The resistor 208 includes a first end portion 214-1 connected to the electrical conductor 202, and a second end portion 214-2 electrically connected to the electrical conductors 204 and 206, respectively. The first end portion 214-1 includes first end segment portions 215-1 and 215-2 of the resistor segments 208-1 and 208-2, respectively, and the second end portion 214-2 includes second end segment portions 215-3 and 215-4 of the resistor segments 208-1 and 208-2, respectively. Additionally, the resistor 208 includes a central portion 216 between the end portions 214-1 and 214-2. The central portion 216 incudes central segment portions 217-1 and 217-2 of the resistor segments 208-1 and 208-2, respectively.

Due to the presence of the thermal control gaps 212-1, 212-2, 212-3, and 212-4, the end portions of each resistor segment 208-1 or 208-2 is fork-shaped with two prongs separated by the corresponding thermal control gap.

The presence of the thermal control gaps 212-1, 212-2, 212-3, and 212-4 in the end portions 214-1 and 214-4 of the resistor 208 is to effectively reduce the cross-sectional area available for electrical current flow in the end portions 214-1 and 214-2, as compared to the cross-sectional area available for electrical current flow in the central portion 216 of the resistor 208.

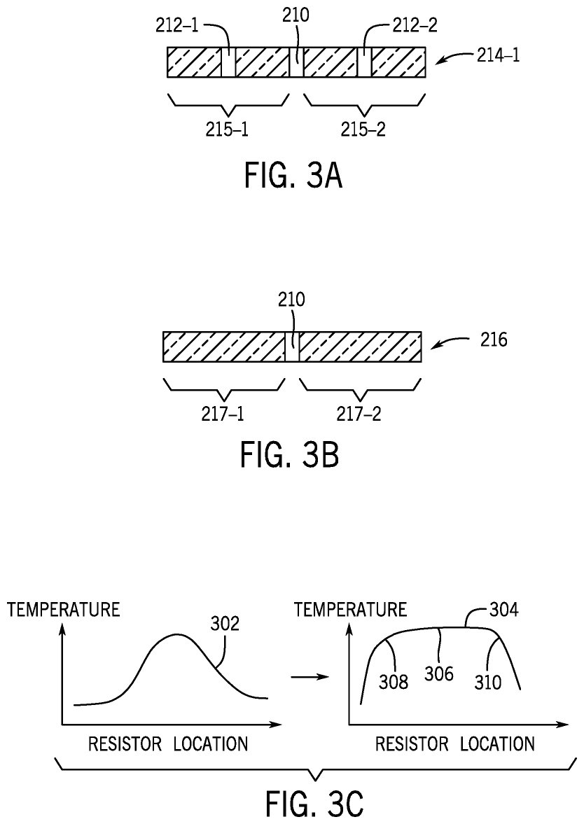

FIG. 3A shows a cross-sectional view of the end portion 214-1 taken along section 3A-3A in FIG. 2. FIG. 3B shows a cross-sectional view of the central portion 216 taken along section 3B-3B in FIG. 2. In FIGS. 3A and 3B, layers below or above the resistor 208 are not shown.

The effective cross-sectional area that includes a resistive material of the central portion 216 of the resistor 208 (FIG. 3B) is greater than the cross-sectional area that includes the resistive material of the end portion 214-1. Accordingly, the end portion 214-1, due to the reduced amount of resistive material because of the presence of gaps (including the thermal control gaps 212-1, 212-2, and the longitudinal gap 210) leads to higher resistance experienced by current flow in the end portion 214-1 than in the central portion 216, which includes just the longitudinal gap 210 without the thermal control gaps.

FIG. 3C shows an example that includes a thermal profile 302 for a resistor without thermal control gaps, and a thermal profile 304 for the resistor 208 with the thermal control gaps 212-1, 212-2, 212-3, and 212-4. Each profile 302 and 304 is represented by a curve that plots temperature to a resistor location along the length of the resistor (the length extends from one electrical conductor to another electrical conductor).

The thermal profile 302 for the resistor without thermal control gaps is Gaussian, with a sharp peak at the center (which can lead to a hotspot of the resistor). The thermal profile 304 for the resistor 208 with the thermal control gaps is more flattened, with the temperature at the center 306 closer to the temperatures at the ends 308 and 310 as compared to the Gaussian profile 302.

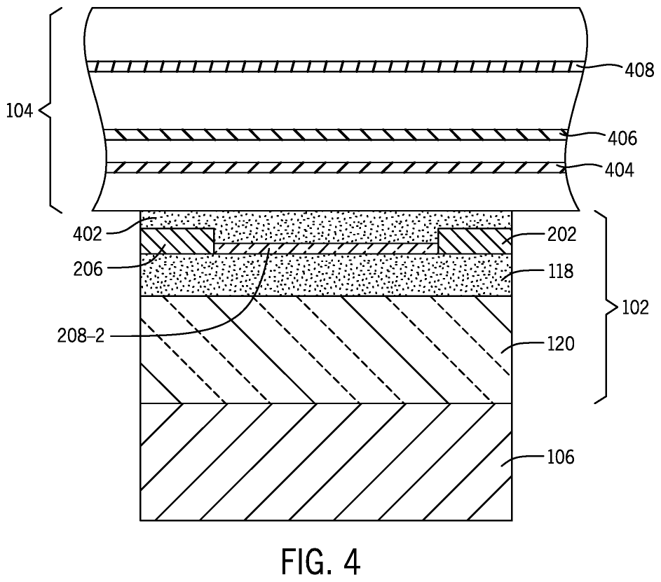

FIG. 4 shows another sectional view of a thermal printer that includes the resistor 208, taken along section 4-4 in FIG. 2. The sectional view of FIG. 4 is along the resistor segment 208-2. FIG. 4 shows the backing plate 106 as the bottom layer, the ceramic layer 120 over the backing plate 106, and the glass layer 118 over the ceramic layer 120.

In addition, a heating element (114 in FIG. 1) is formed over the glass layer 118, where the heating element includes electrical conductors 206 and 202 and the resistor segment 208-2 connected between the conductors 206 and 202.

The thermal printhead 102 further includes an overcoat layer 402 (FIG. 4). The overcoat layer 402 can include an electrically insulating material, such as SiN or a different material. The overcoat layer 402 covers the electrical conductors 206 and 202, and the resistor 208. More generally, the overcoat layer 402 covers an array of resistors 208 and the electrical conductors that are connected to the resistors 208.

FIG. 4 also shows a thermal print medium 104 in the proximity of the thermal printhead 102. Heat generated by an activated resistor 208 is propagated to the thermal print medium 104.

The thermal print medium 104 includes a number of layers, including heat-sensitive color-forming layers 404, 406, and 408 that correspond to different colors. For example, the heat-sensitive color-forming layer 404 closest to the thermal printhead 102 in the orientation shown in FIG. 4 is a yellow color layer. The heat-sensitive color-forming layer 406 that is the next closest to the thermal printhead 102 is a magenta color layer. The heat-sensitive color-forming layers 408 that is farthest away from the thermal printhead 102 in the orientation shown in FIG. 4 is a cyan color layer. In other examples, the heat-sensitive color-forming layers 404, 406, and 408 can form other colors.

Also, in further examples, instead of using different heat-sensitive color-forming layers to form different colors, one layer of the thermal print medium 104 can include different heat-sensitive color-forming portions for different colors.

The heat-sensitive color-forming layers 404, 406, and 408 are separated from one another by interlayers, which can be formed of a polymer or another material. The different heat-sensitive color-forming layers 404, 406, and 408 are activated at different temperatures. For example, the heat-sensitive color-forming layer 404 (e.g., yellow) activates at a first temperature, the heat-sensitive color-forming layer 406 (e.g., magenta) activates at a second temperature less than the first temperature, and the heat-sensitive color-forming layer 408 (e.g., cyan) activates at a third temperature less than the second temperature.

For example, if the heating element 114 generates heat sufficient to heat the heat-sensitive color-forming layer 408 to the third temperature, but insufficient to heat cause the other heat-sensitive color-forming layers 404 and 406 to reach their respective activation temperatures, then just the heat-sensitive color-forming layer 408 will activate.

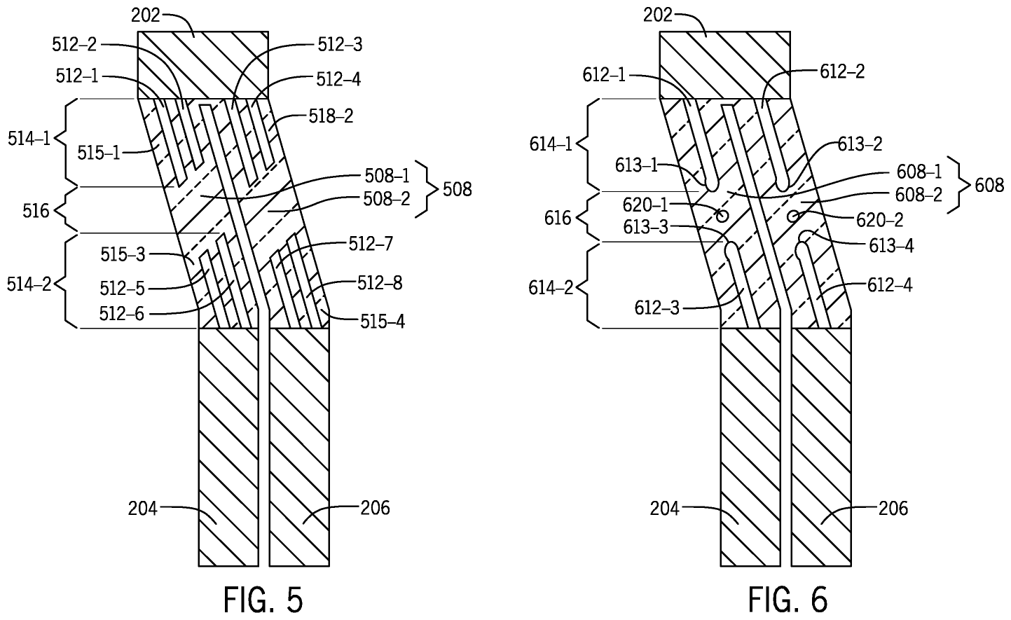

FIG. 5 shows another example resistor 508 (e.g., a split resistor having resistor segments 508-1 and 508-2) that includes a larger number of thermal control gaps 512-1 to 512-7 in the end portions 514-1 and 514-2 of the resistor 508 (as compared to the resistor 208 of FIG. 2). A central portion of the resistor 508 is connected between the end portions 514-1 and 514-2.

The first end portion 514-1 includes first end segment portions 515-1 and 515-2 of the resistor segments 508-1 and 508-2, respectively, and the second end portion 514-2 includes second end segment portions 515-3 and 515-4 of the resistor segments 508-1 and 508-2, respectively.

In the example of FIG. 5, each end segment portion 515-1, 515-2, 515-3, or 515-4 includes two thermal control gaps, rather than the one thermal control gap included in each end segment portion 215-1, 215-2, 215-3, or 215-4 of FIG. 2. The end segment portion 515-1 includes thermal control gaps 512-1 and 512-2, the end segment portion 515-2 includes thermal control gaps 512-3 and 512-4, the end segment portion 515-3 includes thermal control gaps 512-5 and 512-6, and the end segment portion 515-4 includes thermal control gaps 512-7 and 512-8.

Each end segment portion 515-1, 515-2, 515-3, or 515-4 is fork-shaped with three prongs.

In other examples, end portions of a resistor can include a different number of thermal control gaps (different from that shown in FIGS. 2 and 5).

FIG. 6 illustrates another example resistor 608 (e.g., a split resistor having resistor segments 608-1 and 608-2) that uses thermal control gaps 612-1 to 612-4 with curved ends 613-1 to 613-4 as compared to the corresponding rectangular ends of the thermal control gaps 212-1 to 212-4 of FIG. 2. In addition, in FIG. 6, a central portion 616 of the resistor 608 between end portions 614-1 and 614-2 of the resistor 608 includes small thermal control gaps 620-1 and 620-2 provided in respective resistor segments 608-1 and 608-2.

In the foregoing examples, thermal control gaps are depicted as being generally polygonal blank openings, such as the rectangular openings shown in FIGS. 2 and 5, and the generally rectangular openings with curved ends 613-1 to 613-4 shown in FIG. 6.

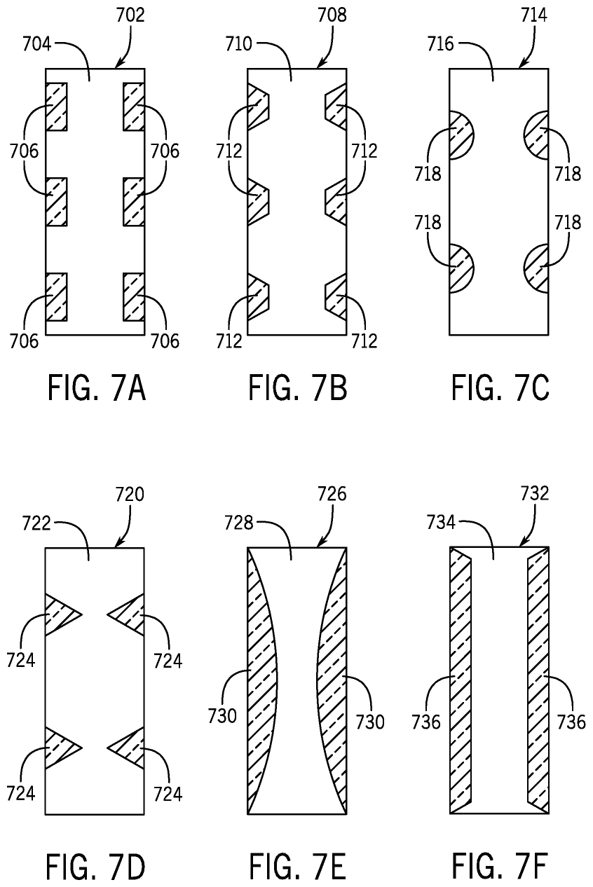

In other examples, instead of using blank openings, a thermal control gap can include resistive material portions. As shown in FIG. 7A, a thermal control gap 702 that includes a generally rectangular opening 704 has a sawtooth arrangement of resistive material blocks 706. Each resistive material block 706 is generally rectangular in shape, and the resistive material of each resistive material block 706 is that of the resistor of a heating element.

FIG. 7B shows another example thermal control gap 708 with a generally rectangular opening 710 that has sawtooth arrangement of resistive material blocks 712. Each resistive material block 712 is generally trapezoidal in shape.

FIG. 7C shows another example thermal control gap 714 with a generally rectangular opening 716 that has sawtooth arrangement of resistive material blocks 718. Each resistive material block 718 is generally semi-circular in shape.

FIG. 7D shows another example thermal control gap 720 with a generally rectangular opening 722 that has sawtooth arrangement of resistive material blocks 724. Each resistive material block 724 is generally triangular in shape.

Note that the number of resistive material blocks 706, 712, 718, and 724 in the thermal control gaps 702, 708, 714, and 720, respectively, can be different from that shown. For example, instead of using three resistive material blocks 706 or 712 or two resistive material blocks 718 and 724 on each side as shown in FIG. 7A, 7B, 7C, or 7D, respectively, a smaller number or a larger number of different sized resistive material blocks can be used. Also, in other examples, the resistive material blocks can have other shapes.

FIG. 7E shows another example thermal control gap 726 with a generally rectangular opening 728 that has resistive material blocks 730 on respective sides of the opening 728. Each resistive material block 730 is generally semi-circular in shape.

FIG. 7F shows an example thermal control gap 732 that is a variant of the thermal control gap 726 of FIG. 7E. The thermal control gap 732 has a generally rectangular opening 734 that has resistive material blocks 736 on respective sides of the opening 734. Each resistive material block 736 has a generally trapezoid shape.

In other examples, other types of thermal control gaps with different shapes can be employed.

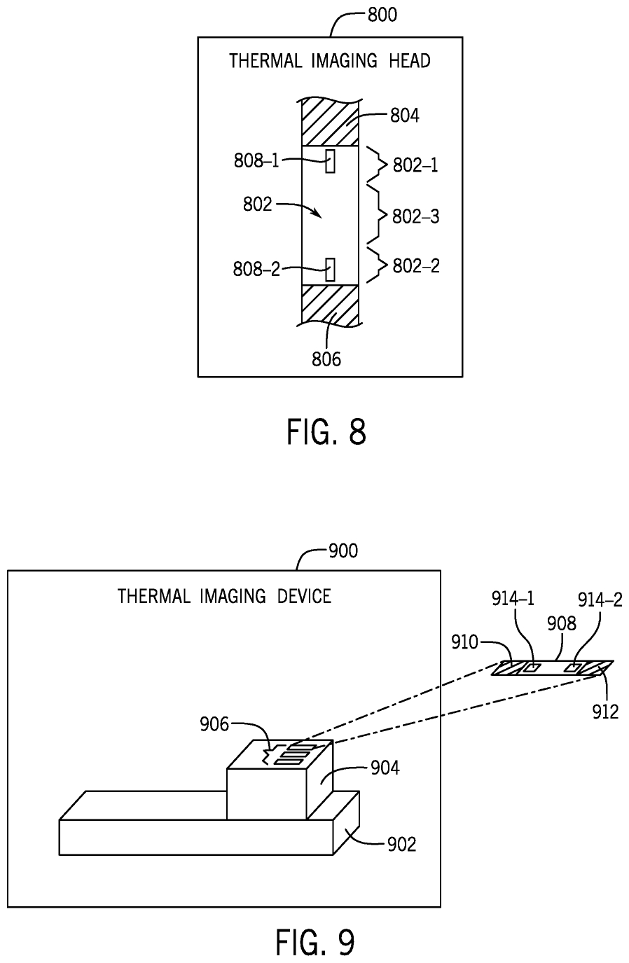

FIG. 8 is a block diagram of a thermal imaging head 800 that includes a resistor 802, and conductors 804 and 806 connected to respective end portions 802-1 and 802-2 of the resistor 802 to pass an electrical current through the resistor 802 The resistor 802 includes thermal control gaps 808-1 and 808-2 at the end portions of the resistor 808. Each gap of the gaps 808-1 and 808-2 reduces a cross-sectional area of a respective end portion of the end portions 802-1 and 802-2 of the resistor 802 relative to a cross-sectional area of a central portion 802-3 of the resistor 802.

FIG. 9 is a block diagram of an imaging device 900 including a support structure 902 and a thermal imaging head 904 on the support structure 902. The thermal imaging head 904 includes an array of resistors 908 connected to conductors 910 and 912 to selectively pass electrical currents through the resistors 908.

Each corresponding resistor 908 of the array of resistors includes thermal control gaps 914-1 and 914-2 at the end portions of the corresponding resistor 908. The end portions of the corresponding resistor 908 are connected to the respective conductors 910 and 912. Each thermal control gap of the thermal control gaps 914-1 and 914-2 reduces a cross-sectional area of a respective end portion of the end portions of the corresponding resistor 908 relative to a cross-sectional area of a central portion of the corresponding resistor 908.

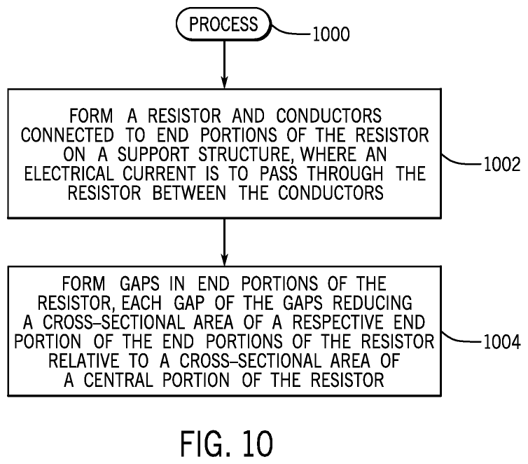

FIG. 10 is a flow diagram of a process 1000 of forming a thermal imaging head according to some examples. The process 1000 includes forming (at 1002) a resistor and conductors connected to end portions of the resistor on a support structure, where an electrical current is to pass through the resistor between the conductors.

The process 1000 further includes forming (at 1004) gaps in end portions of the resistor, each gap of the gaps reducing a cross-sectional area of a respective end portion of the end portions of the resistor relative to a cross-sectional area of a central portion of the resistor.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A thermal imaging head comprising:
a resistor;
conductors connected to end portions of the resistor to pass an electrical current through the resistor,
wherein the resistor comprises gaps at the end portions of the resistor, each gap of the gaps reducing a cross-sectional area of a respective end portion of the end portions of the resistor relative to a cross-sectional area of a central portion of the resistor.

2. The thermal imaging head of claim 1, wherein the reduced cross-sectional area of the respective end portion of the resistor increases a resistance of the respective end portion to electrical current relative to a resistance of the central portion of the resistor.

3. The thermal imaging head of claim 1, wherein the resistor extends from a first conductor of the conductors to second conductor of the conductors, and wherein the electrical current is to flow through the resistor between the first and second conductors.

4. The thermal imaging head of claim 1, wherein each respective end portion of the end portions of the resistor is fork-shaped with a plurality of prongs separated by a respective gap of the gaps.

5. The thermal imaging head of claim 4, wherein the respective gap of each respective end portion separates two prongs of the respective end portion.

6. The thermal imaging head of claim 4, wherein each respective end portion has a plurality of gaps that define more than two prongs of the respective end portion.

7. The thermal imaging head of claim 1, wherein the resistor is a split resistor comprising a first resistor segment connected between a first pair of the conductors, and a second resistor segment connected between a second pair of the conductors, wherein the gaps are formed in segment end portions of each of the first and second resistor segments.

8. The thermal imaging head of claim 1, wherein the gaps in the resistor are filled with a dielectric material.

9. The thermal imaging head of claim 8, wherein the dielectric material comprises a material of an overcoat layer that covers the conductors and the resistor.

10. An imaging device comprising:
a support structure; and
a thermal imaging head on the support structure, the thermal imaging head comprising an array of resistors connected to conductors to selectively pass electrical currents through the resistors,
wherein each corresponding resistor of the array of resistors comprises gaps at the end portions of the corresponding resistor, the end portions of the corresponding resistor connected to corresponding conductors, each gap of the gaps reducing a cross-sectional area of a respective end portion of the end portions of the corresponding resistor relative to a cross-sectional area of a central portion of the corresponding resistor.

11. The imaging device of claim 10, wherein each respective end portion of the end portions of the corresponding resistor is fork-shaped with a plurality of prongs separated by a respective gap.

12. The imaging device of claim 11, wherein the respective gap of each respective end portion separates two prongs of the respective end portion.

13. The imaging device of claim 11, wherein each respective end portion of the corresponding resistor has a plurality of gaps that define more than two prongs of the respective end portion.

14. A method of forming a thermal imaging head, comprising:
forming a resistor and conductors connected to end portions of the resistor on a support structure, wherein an electrical current is to pass through the resistor between the conductors; and
forming gaps in end portions of the resistor, each gap of the gaps reducing a cross-sectional area of a respective end portion of the end portions of the resistor relative to a cross-sectional area of a central portion of the resistor.

15. The method of claim 14, wherein each respective end portion of the end portions of the corresponding resistor is fork-shaped with a plurality of prongs separated by a respective gap.
